(19) United States
(12) Patent Application Publication
(10) Pub. No.: US 2012/0222459 A1
(43) Pub. Date: Sep. 6, 2012

(54) Deadbolt Securing Device

(76) Inventor: Richard Glazar, Gilbert, AZ (US)

(21) Appl. No.: 13/041,420

(22) Filed: Mar. 6, 2011

(51) Int. Cl. E05B 65/00; E05B 17/20

(52) U.S. Cl. 70/91; 70/431

(57) ABSTRACT

This invention has to do with security devices used to retain a deadbolt in a locked position on a door. The device is positioned on over a deadbolt actuating handle and positioned to straddle a doorknob located below the deadbolt handle. The deadbolt actuating handle is prevented from turning to an unlocked position by the device.

### BACKGROUND OF THE INVENTION

1. Field of the Invention

This invention has to do with security devices used to retain a deadbolt in a locked position on a door. The device is positioned on the inside of the door. The door is equipped with a deadbolt actuating handle and a doorknob or door opening handle.

In a preferred embodiment of the invention the device includes descenders or legs extending from a body portion of the device. The descenders are spaced apart and define an open space between them. The descender section of the device is made to fit around and surround the smaller diameter of the doorknob or door handle but the space between the legs isn't wide enough to fit over the enlarged section of the handle portion of a doorknob or door handle. In a broad embodiment of the invention a pair of ascenders or arms extend relatively upward from the body of the device. These ascenders or arms, which may be sides of a square tube in one embodiment, are sufficiently long to engage the handle portion of a deadbolt lock mechanism. The square tube element may be an adjustable length element, for instance, a telescoping tube or otherwise comprise an extension capability. This extendability allows one deadbolt securing device to be adjusted to fit different vertical dimensions between the doorknob and the deadbolt handle. A tubular band or element, having a perimeter; in one embodiment, made up of straight elements, such as square tubing, or in another embodiment; round elements, such as round tubing; or a combination of straight or curved elements; is affixed to the ascenders of the device. The tubular band is normally positioned at the distal end of the ascenders.

2. Description of the State of the Art

The use of a deadbolt lock system is considered a secondary lock system in a conventional exterior door lock set. A deadbolt lock set is much more substantial than a simple lockset incorporated in a keyed tumbler system. It is not unusual to have a keyed tumbler primary lockset used in conjunction with a deadbolt lock system on an external door. It is just this duplication of locksets that gives user's assurance that there is no need for a secondary retainer, such as is provided by the deadbolt security device presented here. Normally, where further security is desired, a door chain or other selectively engageable door swing limiting device will be installed.

There are many embodiments of secondary security lock systems on the market, however, the inventor of this deadbolt securing device, a deadbolt securing device that makes the deadbolt virtually impervious to being defeated by an intruder, is not aware of any device that functions in the same way or as effectively as the device presented in this disclosure.

One of the advantages of the device presented here is that it is very simple to use and is virtually impossible to dislodge from its deadbolt handle securing location when properly positioned.

Another advantage of the deadbolt securing device is that it is inexpensive to manufacture.

Also an advantage of the deadbolt securing device is that there are no moving parts involved in the device.

Another advantage of the deadbolt securing device is that it is not capable of being dislodged from the outside of a locked door.

Also an advantage of the deadbolt securing device is that it is small, compact and easy to handle and store.

One more advantage to the deadbolt securing device is that it can be used by a child or an elderly person without any special technical training

Another advantage is that it is an inexpensive apparatus that will work well to secure a deadbolt to deter intruders from entering a home or business.

In alternative embodiments the deadbolt securing device is adjustable so that different spacing between the doorknob location and the deadbolt handle can be accommodated. In one embodiment there are moving parts that are moved relative to other parts to allow the upper portion of the device to extend away from or toward the lower portion of the device.

Another embodiment of the deadbolt securing device includes extendable descenders that are attached to the descenders of the device to allow the device to extend further between a handle and a dead bolt latch.

The preferred embodiments of the invention presented here are described below in the drawings and detailed specification. Unless specifically noted, it is intended that the words and phrases in the specification and the claims be given the plain, ordinary and accustomed meaning to those of ordinary skill in the applicable arts. If any other special meaning is intended for any word or phrase, the specification will clearly state and define the special meaning Likewise, if a noun, term or phrase is intended to be further characterized or specified, such will include adjectives, descriptive terms or other modifiers in accordance with the normal precepts of English grammar. Absent use of such adjectives, descriptive terms or modifiers, it is the intent the nouns, terms or phrases be given their plain and ordinary English meaning to those skilled in the applicable arts.

Further, the use of the words “function,” “means” or “step” in the Specification is not intended to indicate a desire to invoke the special provisions of 35 U.S.C. 112, Paragraph 6, to define the invention. To the contrary, if the provisions of 35 U.S.C. 112, Paragraph 6 are sought to be invoked to define the inventions, the claims will specifically state the phrases “means for” or “step for,” and will also clearly recite a function, without also reciting in such phrases any structure, material or act in support of the function. Thus, even when the claims recite a “means for” or “step for” performing a defined function, if the claims also recite any structure, material or acts in support of that means or step, or that perform the function, then the intention is not to invoke the provisions of 35 U.S.C. 112, Paragraph 6. Moreover, even if the provisions of 35 U.S.C. 112, Paragraph 6 are invoked to define the claimed inventions, it is intended that the inventions not be limited only to the specific structure, material or acts that are described in the preferred embodiments, but in addition, include any and all structures, materials or acts that perform the claimed function as described in alternative embodiments, or that are well known present or later-developed, equivalent structures, material or acts for performing the claimed function.

### BRIEF DESCRIPTIONS OF THE DRAWINGS

A more complete understanding of the present invention may be derived by referring to the detailed description when considered in connection with the following illustrative figures. In the figures, like reference numbers refer to like elements or acts throughout the figures.

FIG. 1 is a first prospective view of the device.

FIG. 2 is a second prospective view of the device shown in FIG. 1 flipped over to show the obverse side of the device.

FIG. 3 is a view of the device in position on a door handle and deadbolt handle on a broken away portion of a door.

FIG. 4 is a view of an adjustable length device.

FIG. 5 is a view of an adjustable length device where the descenders support descender extensions.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention. It should be noted that there are many different and alternative configurations, devices and technologies to which the disclosed inventions may be applied. The full scope of the inventions is not limited to the examples that are described below.

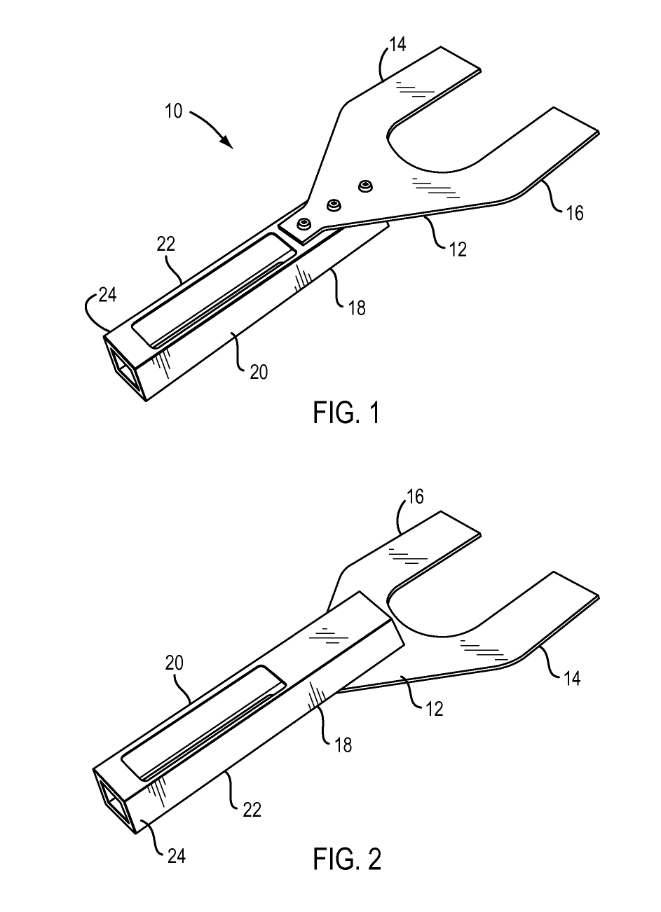

FIGS. 1 and 2 are illustrations of the deadbolt securing device itself

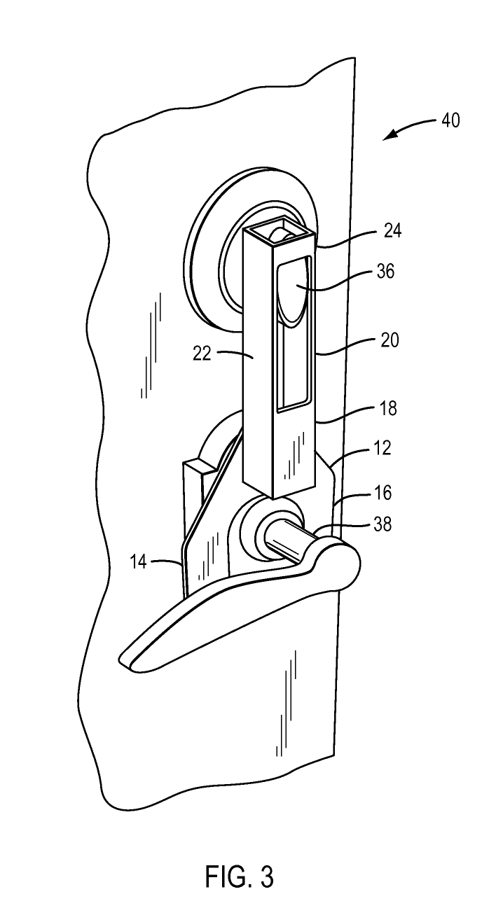

FIG. 3 shows the device as it is positioned on a doorknob and deadbolt handle.

In FIG. 1 the deadbolt securing device, generally 10, is shown. A body 12 is centrally located between the sidewalls of a tube. Extending from the body and away from the tube 18, is a pair of descenders, that being a first descender 14 and a second descender 16. This pair of descenders defines a space for accommodating the shaft section of a doorknob between each of the descenders. The space between the descenders is not wide enough to slip over the widest part, usually the round part, of the doorknob.

Extending generally upwardly from the body 12 is a square tubular structure 18 that forms a first 20 and a second 22 ascender. The ascenders being the sidewalls of the tubular structure 18. These ascenders are spaced apart to be just wider than the width of the deadbolt actuating handle. For instance, the width between the ascenders can be at least one percent greater than the width of the deadbolt actuating handle. The portions between each ascender comprises a web of material. As shown in this embodiment two opposed sides of the square tubing 18, this would be the web portions of the tube between the ascenders, have been cut out of the webs of the square tubing 18 to form an opening in the web and thus a cavity into which a handle of a deadbolt securing device is positioned when the deadbolt securing device is in a positioned and functioning mode as is shown in FIG. 3. It is pointed out that the tubular structure 18 shown in the figures is not the only configuration contemplated by the inventor. Separate ascenders, a round ascender tube, or an otherwise configured ascender configurations are alternative embodiments to the square tubing shown.

At the upper end of the two ascenders 20 and 22 of the ascender tube 18 there is a circumferential ring 24 spanning the distance between the two ascenders 20 and 22 and being the uppermost part of the web between the two ascenders. In the embodiment shown the ring 24 is the distal end of the square tubing 18.

The descenders, 14 and 16, and the ascenders, 20 and 22, extend outwardly from a central body portion 12 as shown in the figures. In the embodiment shown there may be several fasteners, in this case three rivets are shown, that attach the body portion 12 to the tubing section comprised of the tube 18 and ascenders 20 and 22. The fastener selection is not limited to rivets and any similar attaching devices can be used as long as there is a sturdy connection between the body portion 12, the descenders 14 and 16 and the ascenders 20 and 22 or square tube 18 structure. It is also contemplated that the entire structure could be formed as a single piece of material and thus the attachment elements attaching the square tubing to the body of the device can be eliminated. The single piece of material may be cast metal, plastic or other material, even wood, that is shaped, formed, machined or otherwise constructed to provide a structure basically as shown in the figures.

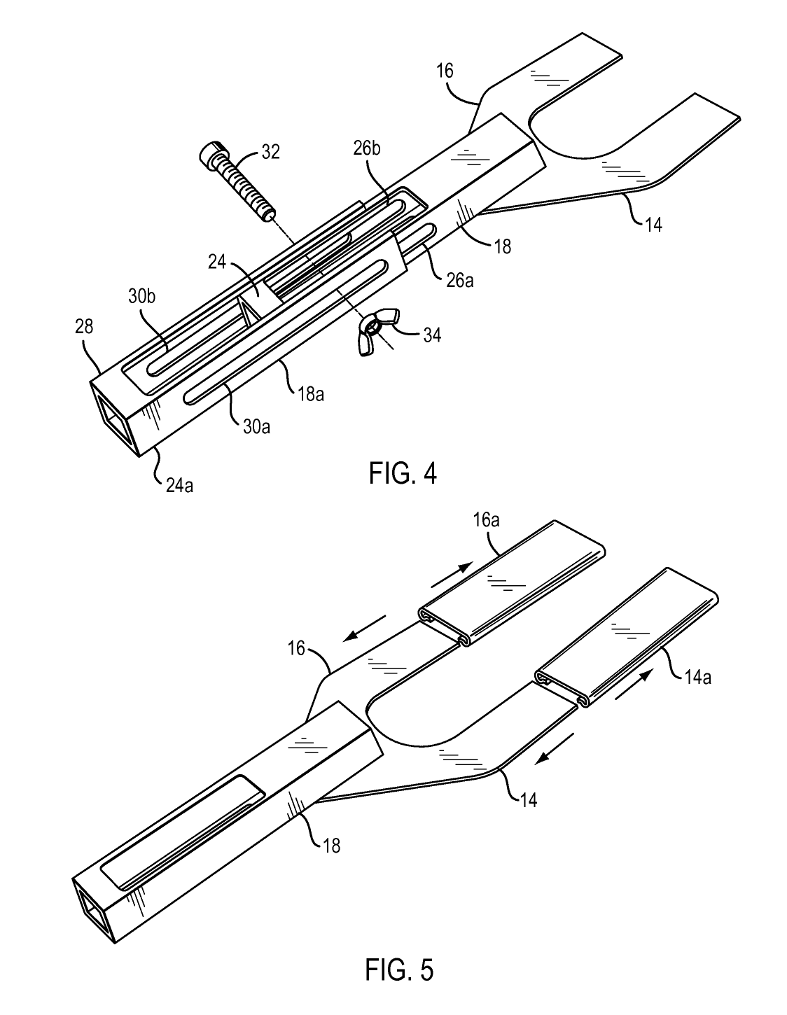

In another embodiment of the device, shown in FIG. 4, the distance between the circumferential ring 24a, similar to and performing the same function as circumferential ring 24, and the top of the opening formed by the descenders 14 and 16 could be an adjustable distance. A slidable connection is provided between the body 12 of the device and the ascenders 20 and 22 of the tube or the descending elements 14 and 16. In FIG. 4 item 18 is modified to have slots 26a and 26b formed in the ascenders of the tube 18. These slots 26a and 26b extend to the circumferential ring 24. An extension 28 has an interior dimension that allows it to fit over the tube 18 in a sliding relationship. This extension will have slots 30a and 30b of dimensions similar to slots 26a and 26b in tube 18. When the extension is positioned in sliding relationship with the tube 18 the slots 26a, 26b, and 30a and 30b will lineup allowing a fastening device such as the bolt 32 to pass through all four slots. A wingnut 34 is threaded on the bolt 32 and when the wingnut is tightened on the bolt 32 the extension is secured to the body 18. The extension 28 has the same cutout holes in the extension tube as in the tube 18. This allows the extension 28 to be placed over the dead bolt latch as shown in FIG. 3 with the non-extended version of the deadbolt securing device. This vertical adjustability of the deadbolt securing device would allow the device to be used through a range of vertical spacings between the location of the deadbolt and the location of the door handle that may be different from door to door. For instance, in some cases the distance between the dead bolt and the shaft of the door handle is eight inches and in some case it is greater or less then eight inches. The adjustable deadbolt securing device could accommodate these differences.

In another embodiment, shown in FIG. 5, an alternative length adjusting system is shown. In this embodiment descender extensions 14a and 16a are provided to slide over the descenders 14 and 16. Each descender extension has a folded over and curved in edge that will tightly grip, but allow friction fit adjustability of the descender extensions 14a and 16a on and to the descenders 14 and 16. It is expected that the descender extenders 14a and 16a could be sold with the basic device or be supplied as an accessory to the device. With either or both of the adjustable devices as shown in FIGS. 4 and 5 the different vertical spacing or distances between a doorknob and a deadbolt handle could be accommodated.

Returning to FIG. 3, the operation or use of the deadbolt securing device is simply a matter of correctly positioning the device on the handle of the host door.

The host door will have a normal door handle, such as a door handle 38 or a doorknob as is well known, located in a standard location on a door, generally 40. No modification of the door, the door handle location, or the normal deadbolt location, usually vertically above the doorknob as is shown, is necessary. The handle portion 36 of the deadbolt lock assembly will be installed such that when the deadbolt is extended into the locked position the handle 36 of the deadbolt will have its major axis in a vertical plane is shown in FIG. 3. The deadbolt handle will be vertical, that is, “up and down” rather than sideways or horizontally disposed.

With the handle 36 of the deadbolt vertical, the deadbolt being in the locked position, the deadbolt securing device, generally 10, will be positioned so that the ascending arms 20 and 22 of the device will each be adjacent to the opposite sides of the deadbolt handle and the deadbolt handle will be in the opening in the web. The circumferential ring 24 at the distal end of the ascenders arms 20 and 22 will slide over the vertically extending portion of the deadbolt handle 36 and a portion of the ring portion 24, carried between the two ascenders, will come to rest on the axle portion of the deadbolt handle 36. In this position the descenders 14 and 16 will bracket the door handle shaft 30 with the weight of the deadbolt securing device 10 supported on the axle portion of the deadbolt handle 36 through its proximity to the circumferential ring 24. In a preferred embodiment the top of the opening between the two descenders 14 and 16 will not rest on the door handle shaft 38 as this could cause the axle of the deadbolt handle 36 to be too far below the lower, inboard edge of the circumferential ring 24.

As can be seen in FIG. 3, with the device 10 in position, the deadbolt handle 36, being in a vertical deployment, any attempt to move the deadbolt handle 36 from the vertical deployment will be resisted by the interior sides of the ascenders 20 and 22. Thus a key inserted into the key slot, even a correct key for the deadbolt, would not be able to turn the deadbolt handle. Similarly, any one trying to pick the deadbolt lock would not be able to turn the deadbolt handle 36 either. This is a simple, effective, failsafe deadbolt handle restrainer that will prevent the deadbolt from being moved from the locked position as shown in FIG. 3 to an unlocked position where the deadbolt handle 36 with be generally horizontal.

In another embodiment of the device only a single ascender is provided. This single ascender extends from the body portion. It is also contemplated that the deadbolt actuating handle receiving portion comprises only a single ascender, with a collar at the top of the single ascender. The single ascender will contact one side of the deadbolt handle when in position.

In the various embodiments discussed above there is a circumferential band attached to the ascender at a location spaced away from the body portion of the deadbolt actuating handle securing apparatus. In an embodiment including a second arm or ascender spaced apart from and forming a cavity with the first arm or ascender, the second arm or ascender is attached to the circumferential band at a location spaced away from the body portion of the deadbolt actuating handle securing apparatus.

As explained above this device is for use in securing a deadbolt actuating handle in a locked position is for use on door that has a doorknob vertically mounted below the deadbolt lock assembly and the deadbolt actuating handle of the assembly.

In summary the invention presented herein includes, at least, a deadbolt actuating handle securing apparatus for use in securing a deadbolt actuating handle in a locked position. The apparatus includes a body portion having a first and a second descender extending from the body portion of the deadbolt actuating handle securing device; and a deadbolt actuating handle receiving portion of the deadbolt actuating handle securing device extending from the body portion of the device away from the first and second descenders. Part of the apparatus is at least a first ascender. In one embodiment there is also a second ascender and the first ascender and the second ascender are connected by a web of material. A circumferential ring connects the first ascender to the second ascender.

The deadbolt actuating handle securing apparatus interfaces with a deadbolt actuating handle through contact between the deadbolt actuating handle and the circumferential ring.

In one embodiment there is a web of material between the first ascender and the second ascender. This web of material defines an opening sufficiently large to accommodate a deadbolt actuating handle of a deadbolt lock assembly. This opening in the web of material is longer than the length of a standard deadbolt actuating handle of a deadbolt lock assembly to easily accommodate the standard deadbolt actuating handle. The opening will be wide enough to accommodate a deadbolt actuating handle of a given width plus at least one percent of the width of the deadbolt actuating handle.

At the other end of the device the first descender and the second descender define a space between the first and the second descenders. In this space the doorknob is surrounded between the first and the second descenders when the device is positioned.

In another an embodiment the device incorporates a length adjustment apparatus carried by the deadbolt actuating handle securing device. Thus the length of the device is adjustable from a short configuration to a longer configuration. This adjustability is provided through an extension slidably connected to the deadbolt actuating handle receiving portion and securable to the receiving portion to maintain the extension in a fixed position on the deadbolt lock handle receiving portion.

In another embodiment giving adjustability there are first and a second descender extensions, each of these descender extension is affixed to one of the first or second descenders. Both of these adjustment embodiments can be incorporated in a single device such that there is an extension slidably connected to the deadbolt actuating handle receiving portion and securable thereto to maintain the extension in a fixed position on the deadbolt actuating handle receiving portion, and a first and a second descender extension, each descender extension affixed to one of the first or second descenders.

While the invention is described herein in terms of preferred embodiments, the inventor contemplates that alterations and permutations of the preferred embodiments will become apparent to those skilled in the art upon a reading of the specification and a study of the drawings.

Accordingly, neither the above description of preferred exemplary embodiments nor the abstract defines or constrains the invention. Rather, the claims variously define the invention. Each variation of the invention is limited only by the recited limitations of its respective claim, and equivalents thereof, without limitation by other terms not present in the claim.

1. A deadbolt actuating handle securing apparatus for use in securing a deadbolt actuating handle in a locked position comprising:
a body portion having a first and a second descender extending from the body portion of the deadbolt actuating handle securing device; and
a deadbolt actuating handle receiving portion of the deadbolt actuating handle securing device extending from the body portion of the device away from the first and second descenders.

2. The invention in accordance with claim 1 wherein the deadbolt actuating handle receiving portion comprises a first ascender.

3. The invention in accordance with claim 1 wherein the deadbolt actuating handle receiving portion comprises:
a first ascender;
a second ascender, the first ascender and the second ascender connected by a web of material; and
a circumferential ring connecting the first ascender to the second ascender.

4. The invention in accordance with claim 3 wherein the deadbolt actuating handle securing apparatus interfaces with a deadbolt actuating handle through contact between the deadbolt actuating handle and the circumferential ring.

5. The invention in accordance with claim 3 wherein web of material between the first ascender and the second ascender comprises structure defining an opening, the opening sufficiently large to accommodate a deadbolt actuating handle of a deadbolt lock assembly.

6. The invention in accordance with claim 5 wherein the opening in the web of material is longer than the length of a standard deadbolt actuating handle of a deadbolt lock assembly.

7. The invention in accordance with claim 3 wherein the first ascender is spaced apart from the second ascender sufficiently far to accommodate a deadbolt actuating handle of a given width plus at least one percent of the width of the deadbolt actuating handle.

8. The invention in accordance with claim 3 further comprising the first descender and the second descender defining a space between the first and the second descenders.

9. The invention in accordance with claim 8 wherein the deadbolt actuating handle securing apparatus for use in securing a deadbolt actuating handle in a locked position is for use on a door, the door having a doorknob vertically mounted below as deadbolt lock assembly and the deadbolt actuating handle of the assembly.

10. The invention in accordance with claim 9 wherein the deadbolt actuating handle securing device is positioned on the deadbolt actuating handle with the deadbolt handle positioned through the opening in the web between the first and the second ascenders with the first ascender and the second ascender adjacent on opposite sides of the deadbolt actuating handle, wherein the deadbolt actuating handle is between each ascender;
the circumferential ring connecting the first ascender to the second ascender is in contact with the deadbolt actuating handle; and
the deadbolt actuating handle securing device further receives the doorknob in the space between the first and the second descenders.

11. A deadbolt actuating handle securing apparatus for use in securing a deadbolt actuating handle in a locked position comprising:
a body portion having a first and a second descender extending from the body portion of the deadbolt actuating handle securing device;
a deadbolt actuating handle receiving portion of the deadbolt actuating handle securing device extending from the body portion of the device away from the first and second descenders, and;
length adjustment apparatus carried by the deadbolt actuating handle securing device whereby the length of the device is adjustable from a short configuration to a longer configuration.

12. The invention in accordance with claim 11 wherein the length adjustment apparatus comprises an extension slidably connected to the deadbolt actuating handle receiving portion and securable thereto to maintain the extension in a fixed position on the deadbolt actuating handle receiving portion.

13. The invention in accordance with claim 11 wherein the length adjustment apparatus comprises a first and a second descender extension, each descender extension affixed to one of the first or second descenders.

14. The invention in accordance with claim 11 wherein the length adjustment apparatus comprises:
an extension slidably connected to the deadbolt actuating handle receiving portion and securable thereto to maintain the extension in a fixed position on the deadbolt actuating handle receiving portion, and
a first and a second descender extension, each descender extension affixed to one of the first or second descenders.

15. A deadbolt actuating handle securing apparatus for use in securing a deadbolt actuating handle in a locked position comprising:
a body portion having a first and a second descender extending from the body portion of the deadbolt actuating handle securing device; and
a deadbolt actuating handle receiving portion extending from the body portion of the device away from the first and second descenders including a first ascender and a second ascender connected together by a web of material and a circumferential ring connecting the first ascender to the second ascender.

16. The invention in accordance with claim 15 wherein the web of material between the first ascender and the second ascender comprises structure defining an opening in the web of material, the opening sufficiently large to accommodate a deadbolt actuating handle of a deadbolt lock assembly.

17. The invention in accordance with claim 16 wherein the first ascender is spaced apart from the second ascender sufficiently far to accommodate a deadbolt actuating handle of a given width.

18. The invention in accordance with claim 15 further comprising length adjustment apparatus including a extension slidably connected to the deadbolt actuating handle receiving portion and securable thereto to maintain the extension in a fixed position on the deadbolt actuating handle receiving portion, and
a first and a second descender extension, each descender extension affixed to one of the first or second descenders.
